(19) United States
(12) Patent Application Publication
(10) Pub. No.: US 2007/0023096 A1
(43) Pub. Date: Feb. 1, 2007

(54) Isolation tool for plugging the interior of a pipeline

(75) Inventors: Wade Scott Buckley, Houston, TX (US); Eric Neal Gage, Houston, TX (US)

Correspondence Address: GABLE & GOTWALS, 100 WEST FIFTH STREET, 10TH FLOOR, TULSA, OK, 74103, US

(73) Assignee: TDW Delaware, Inc.

(21) Appl. No.: 11/193,756

(22) Filed: Jul. 29, 2005

(51) Int. Cl. F16L 55/10

(52) U.S. Cl. 138/89; 138/97; 73/49.8

(57) ABSTRACT

An isolation tool for closing a pipeline including a packer module having a cylindrical body member and at least one ring of elastomeric material slidably received on the cylindrical body, the ring being radially outwardly compressible in response to axial force, and including a grip module having a central body with a plurality of at least three rails radially extending in spaced apart relationship from the central body, each rail having an edge inclined at an angle to a longitudinal axis, a grip shoe contoured to bite into the pipe interior wall surface slidably supported on each inclined edge and a hydraulic cylinder/piston member secured to translate the grip shoes on the rail edges, the grip module being linked to and serving to selectable anchor the packer module in the pipeline.

### REFERENCE TO PENDING APPLICATIONS

This application is not based upon any pending domestic or international patent applications.

### REFERENCE TO MICROFICHE APPENDIX

This application is not referenced in any microfiche appendix.

### BACKGROUND OF THE INVENTION

1. Field of the Invention

This invention relates to an isolation tool for selectably closing the interior of a pipeline and in particular to a pipeline isolation tool that is self-energized by pipeline differential pressure across the plugging apparatus in which the radial sealing and locking pressures exerted against the pipeline are utilized to achieve isolation of portions of the length of the pipeline.

2. Description of the Prior Art

The invention herein is a device for use in pipelines to selectably close the interior of pipelines against fluid flow, either liquids or gases. The isolation tool of this invention may be used, as an example, in a system for pipeline repairs in which a portion of the length of the pipeline is closed against fluid pressure that permits that portion to be repaired. Other applications of the invention includes the use of the isolation tool to close fluid flow through the pipeline such as to control leakage of the fluid from the pipeline due to an accident to the pipeline or due to leakage that can be developed as a consequence of normal degradation of the pipeline due to corrosion. Irrespective of the cause that results in the necessity to close off fluid flow through a pipeline, the isolation tool of this invention may be utilized in the system that provides the possibility of introducing the isolation tool into the pipeline and remotely actuating the device as it travels through the pipeline to stop at a pre-determined location of the pipeline and to close against the internal wall of the pipeline to thereby prevent further fluid flow past the isolation tool. By using a pair of isolation tools that are stopped at different locations in the pipeline, sections of the length of the pipeline may be isolated for repair. The isolation tool of this invention typically is in the form of a train that includes a control module, a grip module and a packer module. However, the particular utility of the modules can be combined in such a way so that the entire isolation tool may consist of separate modules or as few as one module wherein different portions of the module have different functions.

For background information relating to isolation tools and for plugging modules, reference may be had to the following previously issued patents and publications:

| Patent | | |
|---|---|---|
| Number | Inventor | Title |
| 3,011,555 | Clark Jr. | Well Packers |
| 3,107,696 | Ver Nooy | Plugging Pig |
| 3,381,714 | Johnson | Pipeline Blocking Device and |
| | | Process For Its Use |
| 3,483,895 | Barto | Pipeline Shutoff Device |
| 3,886,977 | Dorgebray | Plug For Pipes Under Pressure |
| 4,332,277 | Adkins et al. | Pipeline Pigging Plug |
| 4,390,043 | Ward | Internal Pipeline Plug For Deep |
| | | Subsea Operations |
| 4,422,477 | Wittman et al. | Pressure Energized Pipeline Plug |
| 4,854,384 | Campbell | Pipeline Packer |
| 4,991,651 | Campbell | Pipeline Packer For Plugging A Pipeline |
| | | At A Desired Location |
| 5,209,266 | Hiemsoth | High Pressure Inflatable Plug Device |
| 5,293,905 | Friedrich | Pipeline Pig |
| 5,826,652 | Tapp | Hydraulic Setting Tool |
| 5,924,454 | Dyck et al. | Isolation Tool |
| 6,129,118 | Friedrich et al. | Downstream Plug |
| 6,467,336 | Gotowik | Apparatus For Testing Or Isolating |
| | | A Segment Of Pipe |
| 6,601,437 | Gotowik | Apparatus For Testing or Isolating |
| | | A Segment Of Pipe |
| 6,712,153 | Turley et al. | Resin Impregnated Continuous Fiber |
| | | Plug With Non-Metallic Element |
| | | System |
| 6,752,175 | Willschuetz et | Auxiliary Device For Repairing A |
| | al. | Pipeline |
| PCT NO2003/ | Syse | Arrangement At A Hydraulic Cylinder |
| 000203 | | On A Manoeuvrable Plug For Plugging |
| | | of Pipes |
| PCT NO2003/ | Syse | Device For Fastening A Manoeuvrable |
| 000204 | | Plug For Plugging Of Pipes |

### BRIEF SUMMARY OF THE INVENTION

The isolation tool of this invention basically consists of a command and control module, a grip module and a packer module.

Traditionally an isolation tool packer module is activated by a wedging effect from two components each with a geometric shape resembling a cone. The cone is usually defined by a cone angle of about 17.5°. In the case of isolation tools, the internal cone shaped device is often called the “bowl”.

Grips or slips are segments of a ring which have internal conical surfaces and move axially, with respect to the bowl, in a manner that allows them to expand their collective diameter outward by sliding on the exterior cone of the bowl. The grips have an interior conical face that is in contact with the exterior conical face of the bowl and have an exterior surface that is covered with thread-like teeth. These teeth are the features that come in contact with the pipe wall internal diameter as the grip moves outward along the conical surface of the bowl. The purpose of the teeth is to bite into the pipe and form a non-slip contact as the bowl's movement wedges them tighter against the pipe internal diameter. The real locking action occurs when pipeline pressure is exerted against the large radial face and attempts to push or wedge the conical surface of each bowl under the conical internal diameter of each grip and wedge the grips against the pipeline internal diameter and the bowl.

This system is an effective wedging technique for getting the grips out against the pipe wall. However, it does not provide for a clean transfer of axial force generated by pipeline pressure to achieve a radial force that is sufficient to ensure the grips are adequately held against the pipe wall. The main defect in this well known wedging system is that it relies on conical surfaces. If two conical surfaces of a bowl and grip segments are equal to each other in exactly one axial location, at any other axial location the conical internal diameter will not match the outer diameter of the mating component. The two components will rub against each other in a way that will push low pressure lubrications out of the way. This results in coefficients of friction characterized by bare metal against bare metal.

The grips in the new design of this invention are activated individually via individual hydraulic rams. This feature allows the tool to grip a pipe wall evenly when the pipe internal diameter is not perfectly circular. This feature is superior in axial pressure load distribution than spring compensated systems on current plug technology. The grips are moved towards the pipe wall with a double ended piston. This maintains equal swept volumes during manipulation of the grip positions. The grips of this invention ride along rails from their retracted positions to their extended positions. The use of rails for positioning the grips ensures an equal transfer of axial force from the pipeline pressure to radial force that ensures the grips are adequately held against the pipe wall regardless of pipe wall thickness. Further, the use of rails ensure that there are no design and performance compromises for a wide range of pipe wall thicknesses and tolerances.

Further the support frame in this invention is utilized as the hydraulic distribution manifold for the individual hydraulic cylinders that activate the grips against the pipe wall.

Another unique feature of the new plug design is that the packer module has the ability to adjust the activation factor and thereby adjust to high and low pressure applications without compromising the total induced radial hoop stress that is applied to the pipe wall. The radial hoop stress generated by the plug is a product of the axial force from the pipeline pressure (which is the product of the cross-sectional area of the pipe internal diameter and the pipeline pressure) converted to a rubber pressure in the packer elements. The packers are able to seal because they are situated in a manner that produces a greater pressure against the pipe wall than is generated by the pipeline pressure. This pressure amplification is the mechanism of self-activation and is the product of surface area advantage the pipeline pressure has over the surface area of the packers that is resisting that pressure. If two pistons of different diameters are connected mechanically end to end in correspondingly sized cylinders the same scenario would exist as the relationship between pipeline pressure and packer rubber pressure.

In traditional plugs the pressure head is made of solid construction and presents a unified structure to the pipeline pressure. The entire force from the pipeline pressure is focused through a reduced cross-sectional area of the packer. If a pressure head flange is acted upon by the pipeline pressure, the pressure head flange reacts to the force induced by the pipeline pressure by compressing the packers. Because the cross-sectional area of the packers is smaller than the cross-sectional area of the pipeline internal diameter the pressure built up in the packers to resist the force from the pressure head flange will be larger than the pipeline pressure. The ratio of cross-sectional area of the pipeline internal diameter and the cross-sectional area of the packers is referred to as the “activation factor”.

In the isolation tool of this invention, the pressure head flange cross-sectional area is broken down into two areas and thus divides the load path from the force induced by pipeline pressure into two major components. One load path is through the packers and its source is the reduced cross-sectional area of the pressure head flange that is allowed to compress the packers without moving the hydraulic cylinder assembly; and a second load path which is the load induced by pipeline pressure on the cross-sectional area of the hydraulic cylinder assembly through the piston rod.

This breakup of presented area to the pipeline pressure that creates the force to be routed through the packer elements results in a lower activation factor for the same packer geometry. A unique feature of this invention is that the cylinder can be configured such that its surface induced force will float the cylinder's position towards the pressure head flange and find a load path through the packer as well and not the piston rod. This has the effect of providing a tool with two distinct activation factors. The advantage of this feature is that it gives the tool the ability to have high pressure and low pressure operating ranges. Further it allows the tool to be configured in the pipe and on the fly to operate in both ranges without having to be removed from the pipeline and reconfigured.

Every tool undergoes two modes of the operation called “setting”. The first mode is the “hydraulic set” whereby the internal hydraulic cylinder or other comparable means of constricting the length of the tool causes the packers to be compressed axially and expand the packers outward until they contact the pipe wall internal diameter. This mode initiates the first sealing mechanism of the isolation tool. The second mode uses the force induced from pipeline differential pressure across the plug to further compress the tool axially and drive the packers harder against the pipe wall internal diameter. This mode of operation is pressure set. The force from the pressure set can be and is typically much larger than the hydraulic set. It is desirable to employ the differential pressure to keep the tool set even if it is accidentally instructed to unset via the hydraulics. This constitutes an additional level of safety for the operator that the tool cannot be unset in a situation that may be dangerous to personnel and equipment. If during an isolation project with the tradition style tools the operator's pipeline pressure drops below that required for a safe level the condition could exist that an untrained person could inadvertently command the plug to unset. With the tool of this invention the activation factor can be changed to decrease the required pressure of that safe level so that safe operation can continue.

A better understanding of the invention will be obtained from the following detailed description of the preferred embodiments and claims, taken in conjunction with the attached drawings.

### BRIEF DESCRIPTION OF THE DRAWINGS

FIG. 1 is an elevational view of a modular tool train that includes concepts of the invention. The isolation tool train is made up of flexibly linked modules, including a control module, a grip module and a packer module. The invention herein is concerned essentially with the grip module and the packer module.

FIG. 2 is a cross-sectional view of the control module taken along the line 2-2 of FIG. 1. This figure shows representative means whereby the control module is centrally supported within a pipeline and is representative of the system for controlling the application of hydraulic pressures to the gripper and packer modules.

FIG. 3 is a view taken along the line 3-3 of FIG. 1 showing the construction of the gripper module. FIG. 3 is a partial cross-sectional view along the upper half of the gripper module with the lower half shown in elevational view.

FIG. 4 is a cross-sectional view taken along the line 4-4 of FIG. 1 showing details of a first, although not a preferred embodiment of the packer module.

FIG. 5 is a cross-sectional view of the gripper module as taken along the line 5-5 of FIG. 3.

FIG. 6 is a cross-sectional view of an alternate embodiment of the grip module.

FIG. 7 is a cross-sectional view of a preferred embodiment of a packer module that is similar in many respects to FIG. 4. In this figure, a system is shown providing a two stage type of packer module.

### DETAILED DESCRIPTION OF THE PREFERRED EMBODIMENTS

It is to be understood that the invention that is now to be described is not limited in its application to the details of the construction and arrangement of the parts illustrated in the accompanying drawings. The invention is capable of other embodiments and of being practiced or carried out in a variety of ways. The phraseology and terminology employed herein are for purposes of description and not limitation.

Elements illustrated in the drawings are identified by the following numbers:

| | |
|---|---|
| 10 | Isolation tool |
| 12 | Control module |
| 14 | Grip module |
| 16 | Packer module |
| 18 | Ball joint |
| 20 | Ball joint |
| 24 | Tubular housing |
| 26 A-D | Elastomeric discs |
| 28 | Electronic instrumentation |
| 30 | Hydraulic control compartment |
| 32 | Pipeline |
| 34 | Interior wall |
| 36 | Frame member |
| 38 | Rails |
| 40 | Longitudinal axis |
| 42 | Rail edge |
| 44 | Grip saddle |
| 46 | Inclined edge |
| 48 | Grip shoe |
| 50 | Grip shoe surface |
| 52 | Actuator body |
| 54 | Piston |
| 56 A-B | Opposed cylinder |
| 58 | Intermediate portion |
| 60 | Wheels |
| 62 | Leaf springs |
| 64 | Legs |
| 66 | Small wheels |
| 68 | Forward female half of ball joint 18 |
| 70 | Female half of ball joint 20 |
| 72 | Coiled springs |
| 73 A-B | Packer module |
| 74 | Tubular body |
| 76 | External cylindrical surface |
| 78 | Forward flange |
| 80 | Internal cylindrical surface |
| 82 | Piston rod |
| 84 | Rearward flange |
| 86 | Backup flange |
| 88 | First elastomeric packer |
| 90 | Second elastomeric packer |
| 92 | Internal cylindrical surface |
| 94 | Contacting surface |
| 96 | Sidewall surfaces |
| 98 | Backup ring |
| 100 | Internal opening |
| 102 | Backup ring sidewalls |
| 104 | Outer circumferential surface |
| 106 | Cylinder wall |
| 108 | Piston |
| 112 | Cylinder head |
| 114 | Opening |
| 116 | Cylindrical area |
| 118 | Rearward wheels |
| 120 | Springs |
| 122 | Forward wheels |
| 124 | Ball joint |
| 126 | Cylindrical sidewall |
| 128 | Forward flange |
| 130 | Forward cylinder head |
| 132 | Central opening |
| 134 | Piston rod extension |
| 138 | Coiled springs |

The invention herein provides a system for closing fluid flow through the interior of a pipeline. More specifically, the invention herein relates to improvements in isolation tools in the form of pipeline pig elements that can be transported through a pipeline by the force of fluid flow and remotely actuated so as to stop travel through the pipeline and to form a seal that terminates fluid flow. The type of tools of this invention are known in the industry as “isolation tools” since they can be used to isolate portions of a pipeline. One application of the isolation tools of this invention is to terminate flow from a leaking pipeline. Isolation tools can be used in pairs, spaced apart by a few feet or by many feet, to permit a portion of the pipeline to be repaired or replaced.

The invention herein is not concerned with the specific instrumentation that is utilized to react to a remote signal to cause an isolation tool to set itself in a selected position within a pipeline but instead the invention herein relates to improved mechanisms for removably anchoring the isolation tool at a selected spot within the interior of a pipeline and for closing fluid flow through the pipeline. Stated another way, the invention herein is not concerned primarily or essentially with the electronics by which a pipeline pig is remotely controlled by means from exterior of the pipeline but is concerned with mechanisms that are acted upon by control systems that function in response to remote signals. Stating it even more specifically, the invention herein is in an improved internal pipeline gripper and an improved internal packer and in the combination of an improved gripper and improved packer.

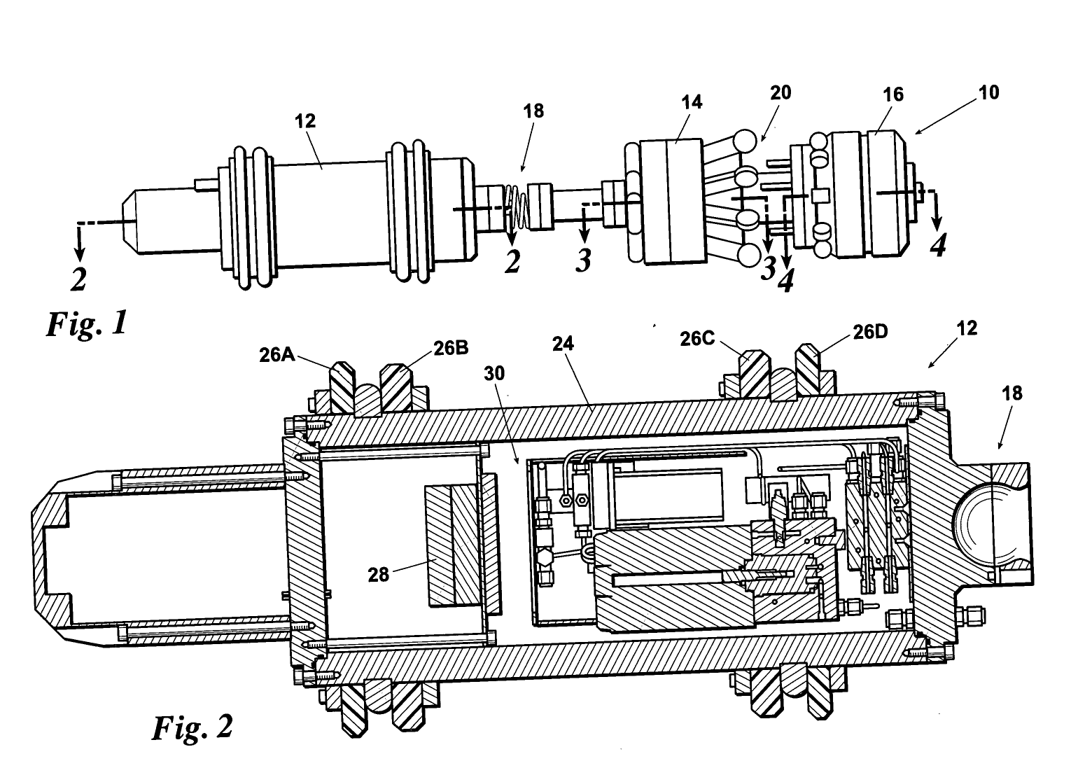

In FIG. 1, an isolation tool is indicated generally by the numeral 10 and is in the form of a train of components flexibly coupled together and configured to travel within a pipeline as a unit and for isolating a portion of the pipeline by closing off fluid flow through it. The isolation tool 10 includes, as major components thereof, a control module 12, a grip module 14 and a packer module 16. The rearward end of grip module 14 is secured to the forward end of control module 12 by means of a ball joint 18. In like manner, the rearward end of packer module 16 is secured to the forward end of grip module 14 by a ball joint 20. Ball joints 18 and 20 are representative of mechanical means of flexibly connecting the basic elements of the isolation tool train to each other so that the train can move around bends in a pipeline without putting stress on the individual connected components.

FIG. 2 is a cross-sectional view showing basic components employed in control module 12. This module includes a housing 24 which is typically tubular as indicated with closed ends and in which the forward closed end includes a portion of ball joint 18. Positioned on the exterior of tubular housing 24 are radially extending elastomeric discs 26A, 26B, 26C and 26D that have exterior diameters that are less than that of the pipeline (not shown) in which the isolation tool train is to be employed. Discs 26A, 26B, 26C and 26D function essentially to support tubular housing 24 centrally within the interior of a pipeline. Elastomeric discs 26 are not intended to necessarily form a tight seal but are primarily designed and constructed as a way of centrally supporting tubular housing 24 within the pipeline in a way that the pipeline will not be damaged.

Within tubular housing 24 of control module 12 there is electronic instrumentation, diagrammatically illustrated and identified by the numeral 28. Instrumentation 28 functions in accordance to known techniques familiar to those in the pipeline pigging and isolation tool industry by which signals can be received from the exterior of a pipeline. A hydraulic control compartment generally indicated by the numeral 30 includes an onboard power source, usually battery powered, hydraulic control valves, actuators and other components as necessary to control the application of hydraulic fluid pressure to the gripper module 14 and the packer module 26. Hydraulic control compartment 30 includes a battery powered hydraulic pump or pumps to supply hydraulic energy as may be needed in the actuation of the grip module 14 and packer module 26.

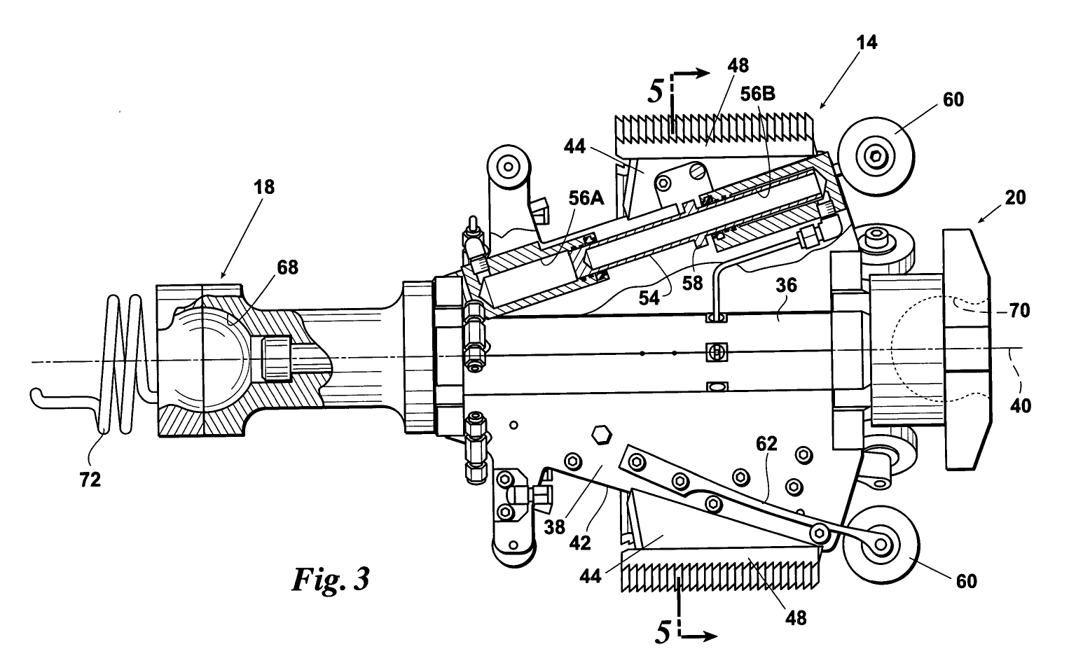

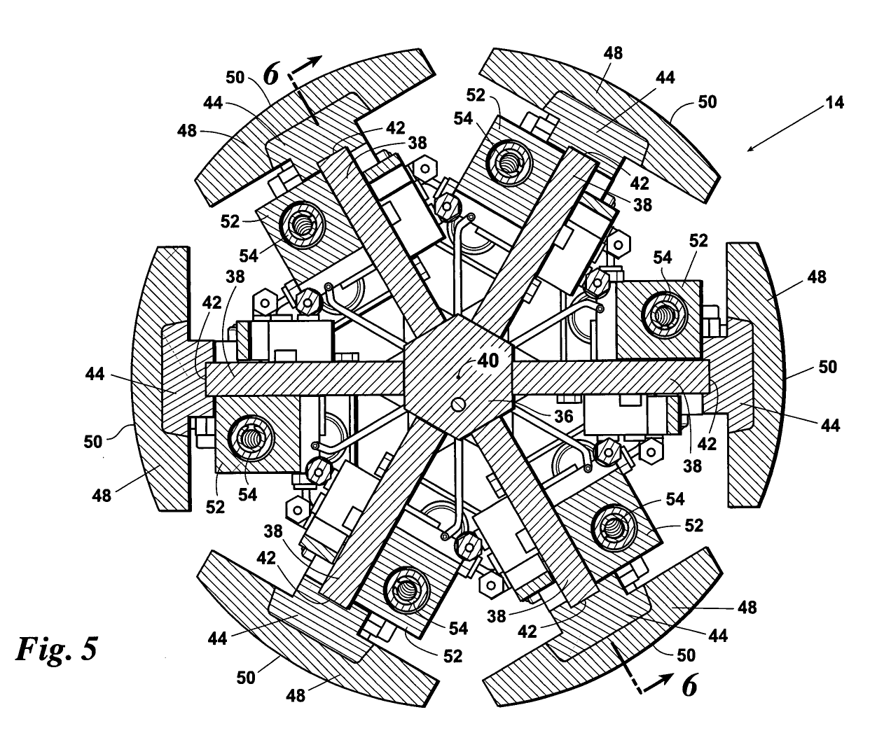

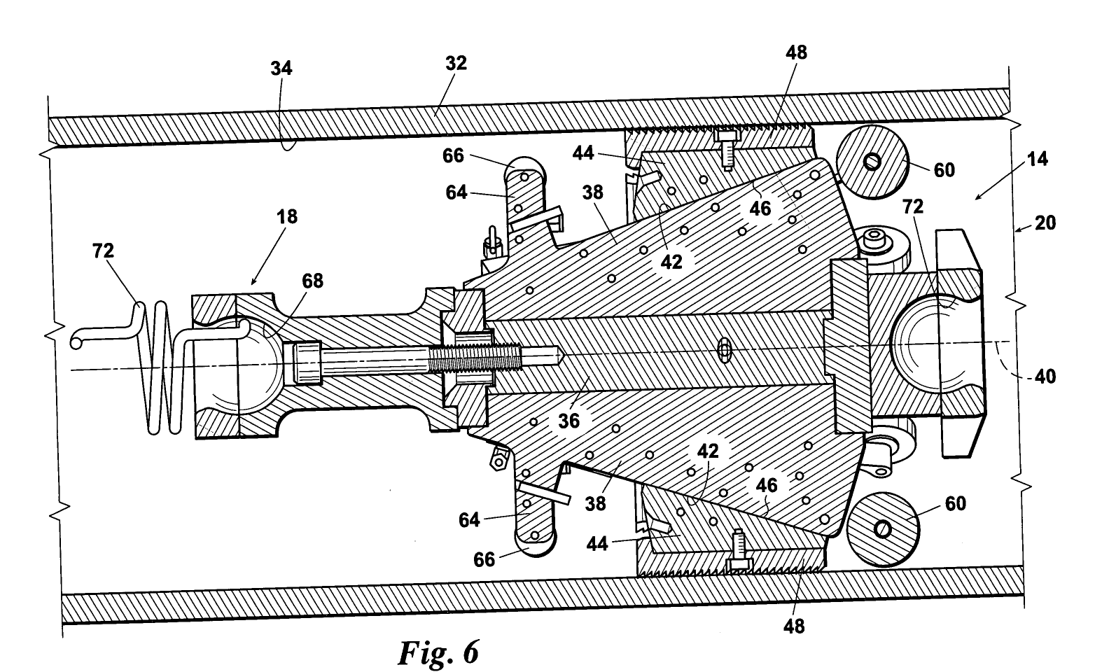

The invention herein is specifically concerned with the systems, methods and construction techniques employed in controlling grip module 14 and packer module 16. The grip module of this invention is illustrated in FIGS. 3, 5 and 6. FIG. 6 shows a pipeline 32 in which grip module 14 is positioned. Referring now to FIGS. 3, 5 and 6, the grip module 14 includes an elongated central body frame member 36 that is shown to be of hexagonal cross-section in FIG. 5. Radially extending from frame member 36 are six radially extending rails 38 each being elongated with flat sides and opposed ends. Rails 38 each extend in a plane of the longitudinal axis 40 of frame member 36. Each of rails 38 is in the form of a flat metal plate with a rail edge 42 that is inclined relative to longitudinal axis 40. Slidably received on each rail edge 42 is a grip saddle 44. Each saddle 44 has an inclined edge 46 that slides on a rail edge 42. Affixed to each of the grip saddle 44 is a grip shoe 48 that has an outer gripping surface 50 configured to engage the interior wall 34 of pipeline 32. Each of the grip shoes 48 is preferably removable and replaceable and has on the grip shoe surface serrated edges as seen in FIGS. 3 and 6 to non-slidably engage pipeline interior wall 34. Further, the angular relationship between rail edge 42 and grip saddle inclined edge 46 is such that the grip shoe surface 50 engage the pipeline interior surface 34 in a parallel relationship.

Secured to a side wall of each of rails 38 is an actuator body 52, best seen in FIG. 5, each of which slidably supports a double ended piston 54 that is best seen in FIG. 3. As seen in FIG. 3, opposed cylinders 56A and 56B are formed in each of the actuator body 52 and slidably receives opposed ends of a piston 54. An intermediate portion 58 of each piston 54 is secured to a grip saddle 44 so that the displacement of each grip saddle 44 and in turn each grip shoe 48 that slides on an edge 42 of each rail 38 is controlled by a piston 54. Each cylinder 56A in each of the actuator bodies 52 is an actuating cylinder. When pressure is applied to the actuating cylinders, pistons 54 function to move the grip saddles 44 and thereby grip shoes 48 in the direction to engage the pipeline interior wall 34. Conversely, when hydraulic pressure is applied to the opposite end, that is, to piston cylinders 56B, grip shoes 58 are moved away from engagement with the pipeline interior wall. In a preferred method of operating the grip module 14, hydraulic pressure is not applied at the same pressure level simultaneously to the actuating cylinders 56A but is preferably supplied in an alternate or sequence method to move the grip shoes individually or at least in pairs rather than all at the same time, to sequentially engage the interior wall of the pipe. This method of actuation is important in order to achieve maximum effective gripping of the interior wall of the pipeline since very few pipelines have interior surfaces that are perfectly cylindrical. Putting it another way, pipelines universally have a slight degree of out of roundness or ovality or differentiations in internal diameters so in actuating hydraulic pistons 54 more effective results can be obtained if pressure applied to cylinders 56A is not simultaneously equal.

It is important that the grip shoes 48 are not in engagement with the interior surface of pipeline, such as surface 34 as seen in FIG. 6, as the isolation tool moves through the pipeline prior to reaching a point where closure of the pipeline is required. For this reason the grip module 14, as seen best in FIGS. 3 and 6, include wheels 60 that roll along the interior surface of the pipeline. Each wheel 60 is rotatably supported at the outer end of a leaf spring 62 as seen in FIG. 3. Each leaf spring 62 is attached at its rearward end to a rail 38. Thus in the embodiment illustrated there are six rails and correspondingly six leaf springs 62 and six wheels 60. Leaf springs 62 force wheels 60 into resilient engagement with the pipeline interior wall and centers the grip module within the pipe as the isolation tool moves through the pipe, the leaf springs serving to flex in response to changes in ovality of the pipeline. To further ensure that grip shoes 48 do not drag on the interior of the pipe, especially if grip module 14 passes irregularities in the pipe wall surface, each rail 38 is provided with an integral radially extending leg 64, each of which has at its outer end a rotatable small wheel 66. These elements are best seen in FIG. 6. When grip saddles 44 are each in their retracted position, wheels 66 extend radially beyond grip shoes 48 and hold them out of contact with the pipeline. Wheels 66 are relatively small and are not intended to normally contact the interior surface of the pipe as the grip module moves through the pipe in contrast with the wheels 60 at the outer end of the leaf springs 62. In other words, the leaf springs 62 and wheels 60 are designed for continuous service as the tool moves through a pipeline however the legs 64 and small wheels 66 are designed to serve as security for protection of the grip shoes in unusual situations.

Leaf springs 62 are illustrated and described as one means of maintaining grip module 14 centered within a pipeline but the invention herein is not limited to the use of leaf springs for this purpose. Other systems exist, well known in the industry, for centering a tool, such as grip-module 14 within a pipeline and such previously known systems may, in some applications be preferable to the use of leaf springs.

As seen in FIG. 1 grip module 14 is connected at its rearward end to ball joint 18 that is positioned between the grip module and control module 12. FIGS. 3 and 6 each show a female half 68 of ball joint 18 and, at the forward end thereof, the female half 70 of ball joint 20. As a part of ball joint 18 is seen in FIGS. 3 and 6 a coil spring 72 is employed for the purposes of preventing relative rotation between the components making up the isolation tool train.

In the embodiment of gripper module 14 shown in FIGS. 3 and 5 separate opposed cylinders 56A and 56B are illustrated to separately actuate each grip saddle 44. This arrangement is optional. In the design of a grip module for a smaller diameter pipeline, instead of separate actuating cylinders a single cylinder can be employed to simultaneously actuate all the grip saddles.

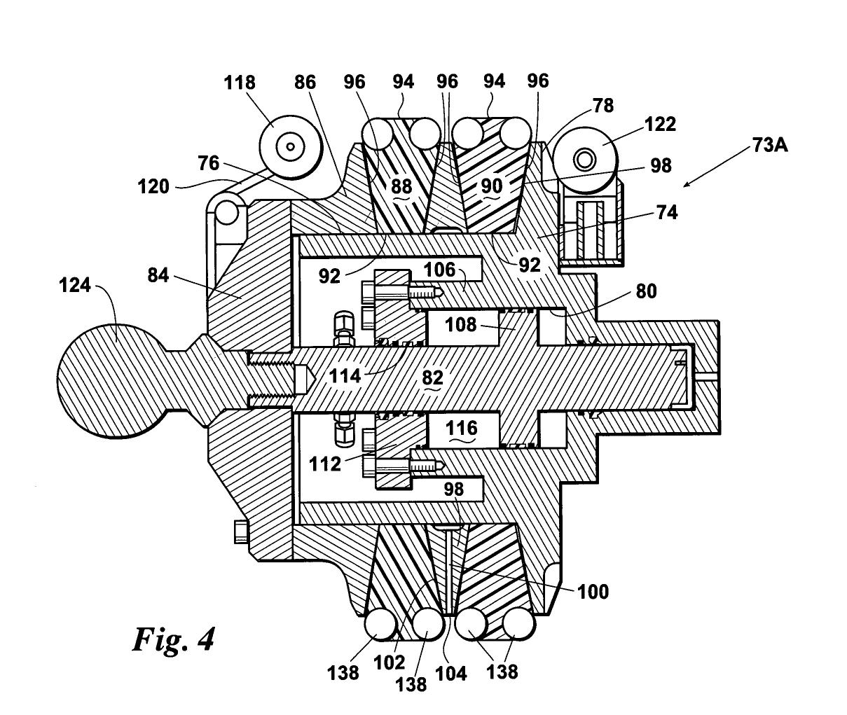

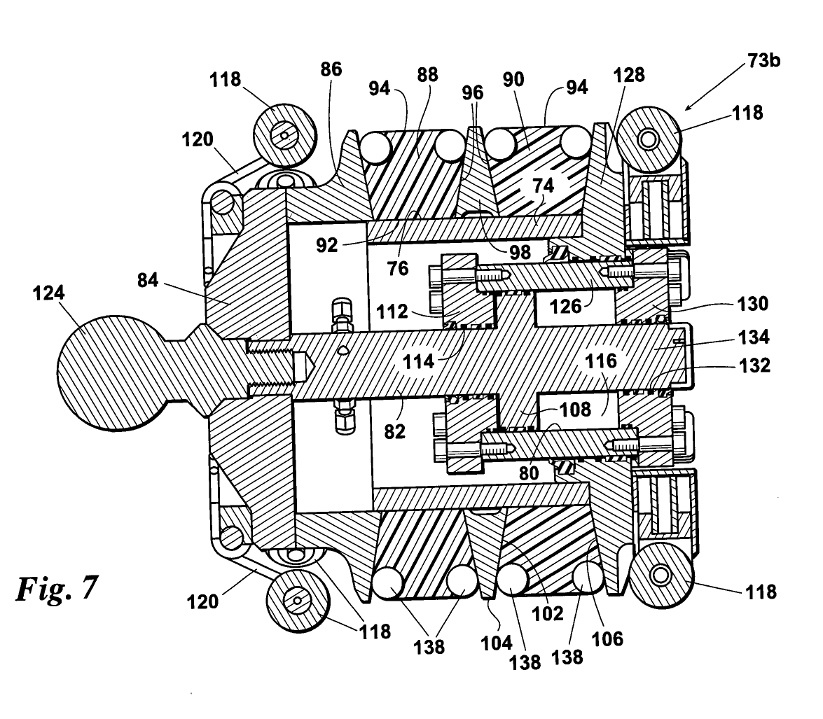

A first embodiment of the packer module, indicated by the numeral 16 in FIG. 1, is illustrated in the cross-sectional view of FIG. 4 and generally identified by 73A while a second and preferred embodiment of the packer module is shown in the cross-sectional view of FIG. 7 and identified by 73B. Reference will first be had to the embodiment 73A of FIG. 4.

In the embodiment of FIG. 4 the packer module 73A includes a tubular body 74 having an external cylindrical surface 76 and, at one end thereof, a radially extending fixed forward flange 78. The tubular body 74 includes a portion defining a cylinder wall 106 with an internal cylinder surface 80. Centrally received within cylindrical wall 106 is a double ended piston rod 82. Secured to a rearward end of piston rod 82 is a radially extending rearward flange 84. In the illustrated embodiment, rearward flange 84 has a central opening that receives a reduced external diameter portion of piston rod 82. Piston rod 82 has a threaded opening in the rearward end thereof that receives a threaded end of a ball joint. Rearward flange 84 is captured between the rearward end of piston rod 82 and the ball joint. Secured to a forward surface of rearward flange 84 is a moveable backup flange 86 that is slidably received on external cylindrical surface 76. Thus backup flange 86 is opposed to fixed forward flange 78.

Received on external cylindrical surface 76 is a first elastomeric packer 88 and an identical second elastomeric packer 90. Each of the elastomeric packers 88 and 90 is, in radial cross-section, frusto-conical, that is, each has sloped wall surfaces. Each of the elastomeric packers have an internal cylindrical surface 92 that is slidably positioned on external cylindrical surface 76. Each of the elastomeric packers has an outer pipe wall contacting surface 94 and connecting the inner and outer surfaces are opposed side wall surfaces 96. The width of the outer contacting surfaces 94 is greater than that of the internal cylindrical surface 92 of each of the elastomeric packers 88 and 90.

Slidably received on the tubular body external cylindrical surface 76 is a backup ring 98 that has a radially extending internal opening 100 therethrough that communicates with external cylindrical surface 76. Backup ring 98 has opposed sidewalls 102 that taper towards the outer circumferential surface 104. Thus the side walls surfaces 102 of backup ring 98 mirror the side wall surfaces 96 of elastomeric packers 88 and 90. Radial internal opening 100 in backup ring 98 can be used to measure pressure between packers 88 and 90.

Formed as a part of tubular body 74 is a cylinder wall 106 that provides internal cylindrical surface 80. Extending radially from piston rod 82 is a piston 108 having an outer cylindrical surface that sealably engages internal cylindrical surface 80.

Affixed at the rearward end of cylinder wall 106 is a cylinder head 112 having an opening 114 therein that receives piston rod 82. Thus there is created within cylindrical wall 106 a cylindrical area 116 that, when pressure is applied thereto tends to move piston 108 forwardly towards the right, and consequently rearward flange 84 and backup flange 86 towards the right, to compress elastomeric packers 88 and 90 against forward flange 78. This action causes the outward displacement of the elastomeric packers so that the outer circumferential surfaces 94 thereof engage the interior wall of a pipeline to thereby close fluid flow through the pipeline. That is, when fluid pressure is applied to cylindrical area 116, as dictated by control module 12, elastomeric packers 88 and 90 are squeezed and radially outwardly expanded to close fluid flow through the pipeline.

In the embodiment of packer module 73A as shown in FIG. 4, forward flange 78 has a sloping cylindrical wall and, in like manner, backup flange 86 has a sloping sidewall 96. Received between these sloping surfaces are first and second elastomeric packers 88 and 90 each with sloping sidewall surfaces 96. The use of sloping surfaces for these components is optional. These surfaces can be radial and the elastomeric packers will then have radial surfaces, that is, the packers will each be in the form of a flat toroid. Whether the elastomeric packers are flat or have frusto-conical sidewalls as shown, the plugging apparatus functions by squeezing the packers to cause radial expansion to close against the internal cylindrical surface of a pipeline.

To support the plugging apparatus of FIG. 4, a number of rearward wheels 118 are radially extended at the outer end of springs 120. While only a single wheel and spring are seen in FIG. 4, it is understood that a minimum of six springs and wheels are radially spaced around the plugging apparatus. In the same way, forward wheels 122 support the forward end of the plugging apparatus away from a pipeline internal wall as the isolation tool train moves through a pipeline.

FIG. 4 shows a ball joint 124 which is a part of the ball joint unit 20 as is identified in FIG. 1 by which the plugging apparatus of FIG. 4 is secured as a part of the isolation tool train.

FIG. 7 is an alternate embodiment of the invention of FIG. 4 wherein the same essential components are assigned the same numbers. A basic difference in these embodiments is that the element 74 identified as a tubular body in FIG. 4 is in FIG. 7 formed of three separate components. These components are a separate cylindrical side wall 126, a separate forward flange 128 that serves the same function as flange 78 in FIG. 4, and a separate forward cylinder head 130 that closes the cylindrical area formed by cylindrical sidewall 126. Forward cylinder head 130 has a central opening 132 that slidably and sealably receives a forward extension 134 of piston rod 82.

An important difference between the embodiment of FIG. 7 compared to that of FIG. 4 is that the forward flange 128 is slidably and sealably secured on the external surface of cylindrical side wall 126. In the embodiment of FIG. 7 fluid pressure can be employed to force flanges 86 and 128 towards each other, squeezing elastomeric packers 88 and 90 to force their outer surfaces into contact with a pipeline interior wall. In addition, fluid pressure within cylindrical sidewall 126 forces piston 108 and thereby piston rod 134 to the right, drawing with it rearward flange 84 and backup flange 86 to further compress elastomeric packers 88 and 90. Thus in the embodiment of FIG. 7 essentially two cylinders provide compressive force to achieve expansion of the elastomeric packers for more effective closure of a pipeline interior.

Each of elastomeric packers 88 and 90 have a pair of circumferentially positioned coiled springs 138 that tend to keep the packers circumferentially collapsed except when they are being squeezed to close fluid flow through a pipeline.

Fluid flow passageways that communicate with pressurized areas within the internal cylindrical surface 80 of FIGS. 4 and 7 and within cylindrical sidewall 126 of FIG. 7 are not seen. They exist in different cross-sectional views of piston rod 82 and the placement of such passageways is a matter of choice to an engineer skilled in the design of hydraulic mechanisms.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification, but is to be limited only by the scope of the attached claim or claims, including the full range of equivalency to which each element thereof is entitled.

What is claimed is:

1. A packer module for selectably closing the interior of a pipe, comprising:
a tubular body having an external cylindrical surface;
a first radial flange on said tubular body of external diameter less than the internal diameter of the pipe;
a hydraulic cylinder concentrically secured in a fixed position within said tubular body having a piston therein, a cylinder head at one end having an opening therethrough sealably receiving an actuating piston rod extending through;
a second radial moveable flange slidably positioned on said tubular body cylindrical surface and spaced from said first flange and of external diameter less than the internal diameter of the pipe and coupled for movement by said piston rod;
at least one elastomeric packer ring received on said tubular body cylindrical surface in engagement with said first and second flanges, a cylindrical surface of said packer in a non-compressed state being slightly less in diameter than the internal diameter of the pipe; and
a source of fluid pressure controllably applicable to said hydraulic cylinder to displace said moveable flange towards said first flange to compress said elastomeric packer and force said external surface thereof into sealable engagement with the pipe.

2. A packer module according to claim 1 wherein said packer ring has opposed frusto-conical sidewalls.

3. A packer module according to claim 1 wherein said first and second radial flanges each have a frusto-conical contacting surface and wherein said packer ring has opposed frusto-conical sidewalls matching said contacting surfaces of said first and second flanges.

4. A packer module according to claim 3 wherein said packer ring is in the form of at least two spaced apart elastomeric packer rings each having said opposed frusto-conical sidewalls, and including a tubular backup ring slidably received on said tubular body cylindrical surface and having opposed frusto-conical sidewalls obverse to and matching with said elastomeric sidewalls of said packer rings, and of external diameter less than the pipe, the backup ring being positioned between and serving to assist said elastomeric rings to expand radially outwardly in response to compression force.

5. A packer module according to claim 1 including:
a bulkhead flange affixed to and extending radially of said piston rod and having an inner radial surface in engagement with and for slidably displacing said first radial flange.

6. A packer module according to claim 1 including a forward cylinder head closing the end of said cylinder opposite said first mentioned cylinder head and having an opening therethrough concentric with said cylinder and including:
a volumetric compensation piston rod extension concentric to said piston and sealably and telescopically received in said opening in said forward cylinder head.

7. An isolation tool according to claim 1 wherein said source of fluid pressure is contained within a control module that is coupled to the packer module for movement by the force of fluid flow through the pipe.

8. For use on an isolation tool having a cylindrical body member for closing a substantial circular pipe interior of internal diameter “D”, a packer comprising:
a ring of elastomeric material having an internal opening defined about a central axis and slidably receivable on the cylindrical body member and having an outer peripheral surface of normal external diameter less than “D” and having opposite frusto-conical sidewall surface, the width of the ring parallel said central axis being reduced adjacent said central opening compared to the width adjacent said outer peripheral surface, and being radially outwardly deflectable in response to axial compressive force.

9. For use on an isolation tool having a cylindrical body member for closing a substantially circular pipe interior of internal diameter “D”, a packer assembly comprising:
a plurality of at least two rings of elastomeric material, each ring having an internal opening defined about a central axis and slidably receivable on the cylindrical body and having an outer peripheral surface of a normal external diameter less than “D” and having opposite frusto-conical sidewall surfaces, the width of the ring parallel said central axis being reduced adjacent said central opening compared to the width adjacent said outer peripheral surface and being radially outwardly deflectable in response to axial compressive force; and
a tubular backup ring of substantially rigid material slidably received on said cylindrical body member between adjacent rings of elastomeric material and having opposed frusto-conical sidewalls obverse to and matching with said sidewalls of said rings of elastomeric materials and having an external diameter less than “D”, said rings of elastomeric material being radially outwardly deflectable in response to axially compressible force applied to the assembly.

10. A grip module for removably latching to the interior of a pipe having a substantially cylindrical interior wall surface, comprising:
a body having a longitudinal axis and guidance members for centralized support within a pipeline;
a plurality of at least three rails radially extending in equally spaced apart relationship from said central body and each having a rail edge inclined at an angle to said longitudinal axis;
a saddle slidably supported on said rail edge;
a hydraulic cylinder/piston member mounted with respect to each said rails and secured to translate said saddles on said rail edges; and
a grip shoe secured to each said saddle and contoured to bite into the pipe interior wall surface.

11. A grip module according to claim 10 including a separate hydraulic cylinder/piston member mounted with respect to each said rail and each secured to separately translate a said saddle on a said rail.

12. A grip module according to claim 10 wherein each said rail is a plate having opposed side surfaces and inner and outer edges, the inner edge being secured to said body and the outer edge providing said inclined edge on which a said saddle is supported.

13. A grip module according to claim 12 wherein a said hydraulic/piston member is secured to a said side surface of each said rail.

14. A grip module according to claim 13 wherein each said hydraulic cylinder/piston member has an axis of piston movement that is parallel to said edge of said rail to which it is mounted.

15. A grip module according to claim 10 including guidance members secured to said body for centralized support of said body within the pipe.

16. A grip module according to claim 15 wherein said guidance members each include a wheel affixed for flexible radial outward displacement for engagement with the pipeline cylindrical interior wall surface.

17. An isolation tool for closing a pipeline having a substantially cylindrical internal wall surface comprising:
a packer module having a cylindrical body member and at least one ring of elastomeric material having an internal opening slidably receivable on the cylindrical body and having an outer peripheral surface of a normal external diameter less than the pipeline internal wall surface, having opposite sidewall surfaces and being radially outwardly deflectable in response to axial compressive force on said sidewall surfaces;
a grip module having a central body and arranged for centralized support within a pipeline;
a plurality of at least three rails radially extending in spaced apart relationship from said central body and each having an edge inclined at an angle to a longitudinal axis;
a grip shoe contoured to bite into the pipe interior wall surface and slidably supported on each said inclined edge; and
a hydraulic cylinder/piston member mounted to said central body to translate said grip shoes on said rail edges, said grip module being linked to and serving to selectable anchor said packer module in the pipeline.
